(19) United States
(12) Patent Application Publication
(10) Pub. No.: US 2020/0063017 A1
(43) Pub. Date: Feb. 27, 2020

(54) METHOD OF REMOVING MINERAL SCALES FROM A SUBSTRATE WITH MINIMIZED CORROSION OF THE SUBSTRATE

(71) Applicant: SOLENIS TECHNOLOGIES, L.P., Wilmington, DE (US)

(72) Inventor: Michael A. Todd, Wilmington, DE (US)

(73) Assignee: SOLENIS TECHNOLOGIES, L.P., Wilmington, DE (US)

(21) Appl. No.: 16/110,221

(22) Filed: Aug. 23, 2018

(51) Int. Cl. C09K 8/528; C09K 8/54; C23G 1/08; C23F 11/04

(52) U.S. Cl. CPC C09K 8/528; C09K 8/54; E21B 41/02; C23F 11/04; C09K 2208/32; C23G 1/08

(57) ABSTRACT

A method of removing mineral scales from a substrate with minimized corrosion of the substrate includes the steps of providing an acid solution providing a corrosion inhibitor solution, applying the acid solution to the substrate to remove mineral scales therefrom, and applying the corrosion inhibitor solution to the substrate to minimize corrosion thereof. The acid solution includes a mineral acid, an organic acid, or a combination thereof. The corrosion inhibitor solution includes an alpha-beta unsaturated aldehyde, a hydrophobic amine, and an oxime. The corrosion inhibitor solution optionally includes formic acid, a surfactant, and a solvent.

### TECHNICAL FIELD

The present disclosure generally relates to a method of removing mineral scales from a substrate with minimized corrosion of the substrate. More specifically, this disclosure relates to a method that utilizes an acid solution and a corrosion inhibitor solution that includes an alpha-beta unsaturated aldehyde, a hydrophobic amine, and an oxime to reduce corrosion.

### BACKGROUND

Geothermal, oil, and gas wells that come in contact with water are likely to develop deposits of inorganic scales thereon. These inorganic scales can coat and/or clog perforations, casings, production tubulars, valves, pumps, and downhole completion equipment, such as safety equipment and gas lift mandrels. If allowed to proceed without remediation or removal, accumulation of the inorganic scales can limit well efficiency and can eventually cause abandonment of the well.

Typically, inorganic scales develop when the wells are in contact with water. Water is a good solvent for many materials and can carry large quantities of scaling minerals. All natural waters contain dissolved components acquired through contact with mineral phases in nature. This gives rise to complex fluids, rich in ions, some of which are at the saturation limit for certain mineral phases. Seawater tends to become rich in ions that are by-products of marine life and water evaporation. Ground water and water in near-surface environments are often dilute and chemically different from deep subsurface water associated with gas and oil. Deep subsurface water becomes enriched in ions through alteration of sedimentary minerals. The water in carbonate and calcite-cemented sandstone reservoirs usually contains an abundance of divalent calcium [Ca²⁺] and magnesium [Mg²⁺] cations. Inorganic scales typically begin to form when the state of the water is perturbed such that the solubility limit for one or more components is exceeded. Mineral solubilities themselves have a complicated dependence on temperature and pressure. Typically, an increase in temperature increases the water solubility of a mineral. More ions are dissolved at higher temperatures. Similarly, decreasing pressure tends to decrease solubilities.

More specifically, when brine, oil, and/or gas move from the bottoms of the wells up towards the surface, pressure and temperature change and certain dissolved salts can precipitate on the various components of the wells. This process is typically described as self-scaling. For example, if a brine is injected into one portion of the well, such as a formation portion, to sweep oil into another portion of the well, such as a production portion, there is a comingling of the brine with formation water. As a result, salts may precipitate in the formation portion, in a wellbore, etc. As just one example, calcite deposition is generally a self-scaling process. The main driver for formation of calcite is the loss of carbon dioxide from water to a hydrocarbon as pressure in a well falls. This action removes carbonic acid from the water such that there is no longer a solvent to keep the calcite dissolved. Calcite solubility in the wells also decreases with decreasing temperature (at constant carbon dioxide partial pressure).

Technology is available for removing inorganic scales from the wells. Scale remediation and prevention can be quite expensive. For example, the cost for taking a single well offline, cleaning the well, and then bringing the well back online to production status can be as expensive as chemically treating an entire field of wells. While not all wells are susceptible to such high maintenance costs, the process of scale formation, remediation, and prevention drives significant costs. Moreover, as the technology of the wells advances, scale removal will become even more critical. For example, as the use of smart wells becomes more popular, scale removal will become more important because the integrity of the smart wells is more important than in older, less technologically advanced wells. As gas production increases, the newer wells also tend to be more sensitive in terms of operating parameters. Finally, as the use of wells increases in general, more water will be produced which can lead to increased self-scaling processes.

To address these issues, many processes have been proposed. Typically, various strong acids, such as hydrochloric acid, are used to remove the inorganic scales from the wells, thereby increasing the efficiency of the wells. However, strong acids are very corrosive to steel and other metal substrates that are present in the wells, e.g. as part of the well casings. This corrosion increases greatly as greater concentrations of acids are used and as temperatures increase up to about 300° C. Therefore, the use of strong acids can be problematic.

Accordingly, there remains an opportunity to develop an improved process for removing mineral scales from wells while minimizing corrosion thereof. Furthermore, other desirable features and characteristics of the present disclosure will become apparent from the subsequent detailed description of the invention and the appended claims, taken in conjunction with the accompanying drawings and this background of the invention.

### BRIEF SUMMARY

This disclosure provides a method of removing mineral scales from a substrate with minimized corrosion of the substrate. The method includes the steps of providing an acid solution, providing a corrosion inhibitor solution, applying the acid solution to the substrate to remove mineral scales therefrom, and applying the corrosion inhibitor solution to the substrate to minimize corrosion thereof. The acid solution includes a mineral acid, an organic acid, or a combination thereof. The corrosion inhibitor solution includes an alpha-beta unsaturated aldehyde, a hydrophobic amine, and an oxime. The corrosion inhibitor solution optionally includes formic acid, a surfactant, and a solvent.

This disclosure also provides an additional embodiment of the method. In this embodiment, the acid solution includes about 5 to about 25 wt % of hydrochloric acid. Also in this embodiment, the corrosion inhibitor solution includes cinnamaldehyde present in an amount of from about 2 to about 50 weight percent of the solution, oleyl-propanediamine present in an amount of from about 0.1 to about 20 weight percent of the solution, methyl ethyl ketoxime present in an amount of from about 0.1 to about 20 weight percent of the solution, formic acid present in an amount of about 25 to about 30 weight percent of the solution, a surfactant present in an amount of from about 5 to about 10 weight percent of the solution, and an alcohol solvent comprising a balance of the solution. Moreover, this embodiment includes the step of applying the acid solution to the steel substrate to remove the calcite scales therefrom and the step of applying the corrosion inhibitor solution to the steel substrate at a temperature of from about 80° C. to about 300° C. to minimize corrosion thereof.

This disclosure even further provides the corrosion inhibitor solution itself including the alpha-beta unsaturated aldehyde, the hydrophobic amine, and the oxime. In this embodiment, the corrosion inhibitor solution optionally includes the formic acid, the surfactant, and the solvent.

### DETAILED DESCRIPTION

The following detailed description is merely exemplary in nature and is not intended to limit the instant method. Furthermore, there is no intention to be bound by any theory presented in the preceding background or the following detailed description.

Embodiments of the present disclosure are generally directed to methods of removing mineral scales from a substrate with minimized corrosion of the substrate. For the sake of brevity, conventional techniques related to removing mineral scales may not be described in detail herein. Moreover, the various tasks and process steps described herein may be incorporated into a more comprehensive procedure or process having additional steps or functionality not described in detail herein. In particular, various steps in the removal of mineral scales are well-known and so, in the interest of brevity, many conventional steps will only be mentioned briefly herein or will be omitted entirely without providing the well-known process details.

This disclosure provides a method of removing mineral scales from a substrate with minimized corrosion of the substrate. The terminology “removing” may describe minimizing the presence of the mineral scales and/or removal or elimination of the mineral scales from the substrate. The method may dissolve the mineral scales such that they are then removed from the substrate with rinsing, e.g. with water.

The mineral scales themselves are not particularly limited and may include, but are not limited to, calcite/aragonite/vaterite (CaCO₃), calcium phosphate (Ca₃(PO₄)₂), silica (SiO₂) anhydrite/gypsum (CaSO₄), barite (BaSO₄), celestite (SrSO₄), mackinawite (FeS), pyrite (FeS₂), halite (NaCl), fluorite (CaF₂), sphaerlite (ZnS), galena (PbS), or combinations thereof. In other embodiments, the mineral scales are chosen from calcite/aragonite/vaterite (CaCO₃), calcium phosphate (Ca₃(PO₄)₂), silica (SiO₂), and combinations thereof. In other embodiments, the mineral scales are chosen from calcium carbonate, calcium sulfate, barium sulfate, strontium sulfate, iron sulfide, iron oxides, iron carbonate, silicates and phosphates and oxides, thereof, or combinations thereof. In further embodiments, the mineral scales may be any compounds known in the art to be present in gas, oil, and/or geothermal wells that are insoluble or slightly soluble in water.

The mineral scales may be further defined as described above and/or as a deposit or coating formed on the surface of the substrate caused by a precipitation due to a chemical reaction with the surface, precipitation caused by chemical reactions, a change in pressure or temperature, or a change in the composition of a solution.

Referring now to the substrate, the substrate may be any known in the art to have mineral scales disposed thereon. For example, the substrate may be stainless steel, C1010 steel, K55 steel, etc. In other embodiments, the substrate is or includes C1010 steel or K55 steel. In still other embodiments, the substrate may be any other metallurgy known in the art. In further embodiments, the substrate may be any portion of a gas, oil, or geothermal well, such as a well casing. For example, the mineral scales may be described as a mineral salt deposit that may occur on wellbore tubulars and components as saturation of produced water is affected by changing temperature and pressure conditions in a production conduit. In severe conditions, the mineral scales may create a significant restriction, or even a plug, in production tubing.

In other embodiments, the substrate can be defined as perforations, casings, production tubing, valves, pumps, downhole completion equipment, wellbores, water paths from injectors through reservoirs to surface equipment, pores near wellbores, perforations in production tubing, safety valves, gas-lift mandrels, etc. The substrate may be any piece of equipment used in oil, gas, or geothermal wells.

The method includes the step of providing an acid solution. The acid solution includes a mineral acid, an organic acid, or a combination thereof. The mineral acid, organic acid, or combination thereof may be present in the acid solution in any amount as chosen by one of skill in the art. In various embodiments, the acid solution includes about 5 to about 25, about 5 to about 20, about 10 to about 25, about 10 to about 15, about 15 to about 25, about 15 to about 20, or about 20 to about 25, wt % of a mineral acid, an organic acid, or a combination thereof. The balance of the acid solution is typically water. For example, the acid solution typically includes about 75 to about 95 wt % of water to balance the about 5 to about 25 wt % of the mineral acid, organic acid, or combination thereof. In various non-limiting embodiments, all values and ranges of values including and between those set forth above are hereby expressly contemplated for use herein.

The mineral acid and/or organic acid may be any known in the art. In one embodiment, the mineral acid is an acid derived from one or more inorganic compounds that forms hydrogen ions and a conjugate base when dissolved in water. Mineral acids typically range from superacids (e.g. perchloric acid) to very weak acids (e.g. boric acid). Mineral acids tend to be very soluble in water and insoluble in organic solvents. In various embodiments, the mineral acid is chosen from hydrochloric acid (HCl), nitric acid (HNO₃), phosphoric acid (H₃PO₄), sulfuric acid (H₂SO₄), boric acid (H₃BO₃), hydrofluoric acid (HF), hydrobromic acid (HBr), perchloric acid (HClO₄), hydroiodic acid (HI), and combinations thereof. In one embodiment, the mineral acid is hydrochloric acid (HCl).

Additionally, the organic acid may also be any known in the art. An organic acid is an organic compound that forms a conjugate base, the stability of which, tends to determine acidic properties. Non-limiting suitable organic acids are carboxylic acids, sulfonic acids, phosphoric acids, etc. In various embodiments, the organic acid is chosen from formic acid (methanoic acid), acetic acid (ethanoic acid), propionic acid (propanoic acid), butyric acid (butanoic acid), valeric acid (pentanoic acid), caproic acid (hexanoic acid), oxalic acid (ethanedioic acid), lactic acid (2-hydroxypropanoic acid), malic acid (2-hydroxybutanedioic acid), citric acid (2-hydroxypropane-1,2,3-tricarboxylic acid), benzoic acid (benzenecarboxylic acid), carbonic acid (hydroxymethanoic acid), phenol (carbolic acid or hydroxybenzene), uric acid (7,9-Dihydro-1H-purine-2,6,8(3H)-trione), taurine (2-aminoethanesulfonic acid), p-toluenesulfonic acid (4-methylbenzenesulfonic acid), trifluoromethanesulfonic acid (triflic acid), aminomethylphosphonic acid, and combinations thereof.

The method also includes the step of providing a corrosion inhibitor solution hereinafter described as the “inhibitor solution.” The inhibitor solution includes an alpha-beta unsaturated aldehyde, a hydrophobic amine, and an oxime. The inhibitor solution may also optionally include, or be free of, one or more of formic acid, a surfactant, and a solvent. In various embodiments, the inhibitor solution is, consists essentially of, or consists of the alpha-beta unsaturated aldehyde, the hydrophobic amine, and the oxime. In other embodiments, the inhibitor solution, is, consists essentially of, or consists of, the alpha-beta unsaturated aldehyde, the hydrophobic amine, the oxime, and one or more of the formic acid, the surfactant, and the solvent. The terminology “consists essentially of” can describe various embodiments of the inhibitor solution wherein the inhibitor solution is free of, or includes less than 5, 4, 3, 2, 1, 0.5, or 0.1, weight percent, additional alpha-beta unsaturated aldehydes, additional hydrophobic amines, or additional oximes, apart from the ones described herein, or optionally also formic acid, one or more surfactants, one or more solvents, one or more additives known in the art which may include any described below, or combinations thereof, provided that the inhibitor solution includes at least one alpha-beta unsaturated aldehyde, at least one hydrophobic amine, and at least one oxime.

The inhibitor solution may be combined with the acid solution, as is described in greater detail below. As such, the inhibitor solution itself may include a particular weight percent of the various components. After combination with the acid solution, the weight percent of the various components may then change. These differences in amounts are set forth below relative to the various components.

The alpha-beta unsaturated aldehyde may be any known in the art. In various embodiments, the alpha-beta unsaturated aldehyde has 4 to 20, 5 to 19, 6 to 18, 7 to 17, 8 to 16, 9 to 15, 10 to 14, 11 to 13, or 12, carbon atoms. Alternatively, the alpha-beta unsaturated aldehyde may include one or more alkyl or alkenyl groups having any number of carbon atoms as described above and which may be linear, branched, or cyclic. Moreover, the alpha-beta unsaturated aldehyde may include one or more aromatic groups, such as a benzyl group. In various non-limiting embodiments, all values and ranges of values including and between those set forth above are hereby expressly contemplated for use herein.

In various embodiments, the alpha-beta unsaturated aldehyde has the formula:

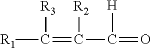

In this formula, R₁ is a saturated or unsaturated aliphatic hydrocarbon group including from about 3 to about 12 carbon atoms, a substituted saturated or unsaturated aliphatic hydrocarbon group including from about 3 to about 12 carbon atoms and also including one or more non-interfering substituents, an aryl group, e.g., phenyl, benzyl or the like, a substituted aryl group including one or more non-interfering substituents, or a non-interfering substituent. Moreover, R₂ is hydrogen, a saturated or unsaturated aliphatic hydrocarbon group including from 1 to about 5 carbon atoms, a substituted saturated aliphatic hydrocarbon group including from 1 to about 5 carbon atoms and also including one or more noninterfering substitutents, an aryl group, a substituted aryl group including one or more non-interfering substitutents, or a non-interfering substituent. Moreover, R₃ is hydrogen, a saturated or unsaturated aliphatic hydrocarbon group including from about 3 to about 12 carbon atoms, a substituted saturated or unsaturated aliphatic hydrocarbon group including from about 3 to about 12 carbon atoms and also including one or more non-interfering substituents, an aryl group, a substituted aryl group including one or more non-interfering substituents, or a non-interfering substituent. Furthermore, in this formula, the total number of carbon atoms in each of the substituents represented by R₁, R₂ and R₃ is independently from 1 to about 16, and typically from about 5 to about 10.

Non-interfering substituents described above which replace hydrogen on the alpha- and beta- carbon atoms of the aldehydes or which are found in hydrocarbon substituents which replace hydrogen on these carbon atoms may include, for example, lower alkyl (including from 1 to about 4 carbon atoms), lower alkoxy (including from 1 to about 4 carbon atoms), halo, i.e., fluoro, chloro, bromo or iodo, hydroxyl, dialkylamino, cyano, thiocyano, N,N-dialkylcarbamoylthio and nitro substituents.

In various embodiments, the alpha-beta unsaturated aldehyde may be chosen from crotonaldehyde, 2-hexenal, 2-heptenal, 2-octenal, 2-nonenal, 2-decenal, 2-undecenal, 2-dodecenal, 2,4-hexadienal, 2,4-heptadienal, 2,4-octadienal, 2,4-nonadienal, 2,4-decadienal, 2,4-undecadienal, 2,4-dodecadienal, 2,6-dodecadienal, citral, 1-formyl-[2-(2-methylvinyl)]-2-n-octylethylene, cinnamaldehyde, dicinnamaldehyde, p-hydroxycinnamaldehyde, p-methylcinnamaldehyde, p-ethylcinnamaldehyde, p-methoxycinnamaldehyde, p-dimethylaminocinnamaldehyde, p-diethylaminocinnamaldehyde, p-nitrocinnamaldehyde, o-nitrocinnamaldehyde, o-allyloxycinnamaldehyde, 4-(3-propenal)cinnamaldehyde, p-sodium sulfocinnamaldehyde, p-trimethylammoniumcinnamaldehyde sulfate, p-trimethylammoniumcinnamaldehyde o-methylsulfate, p-thiocyanocinnamaldehyde, p-(S-acetyl)thiocinnamaldehyde, p-(S-N,N-dimethylcarbamoylthio)cinnamaldehyde, p-chlorocinnamaldehyde, 5-phenyl-2,4-pentadienal, 5-(p-methoxyphenyl)-2,4-pentadienal, 2,3 -diphenylacrolein, 3,3 -diphenylacrolein, alpha-methylcinnamaldehyde, beta-methylcinnamaldehyde, alpha-chlorocinnamaldehyde, alpha-bromocinnamaldehyde, alpha-butylcinnamaldehyde, alpha-amylcinnamaldehyde, alpha-hexylcinnamaldehyde, 2-(p-methylbenzylidine)decanal, alpha-bromo-p-cyanocinnamaldehyde, alpha-ethyl-p-methylcinnamaldehyde, p-methyl-alpha-pentylcinnamaldehyde, 3,4-dimethoxy-alpha-methylcinnamaldehyde, alpha-[(4-methylphenyl)methylene]benzeneacetaldehyde, alpha-(hydroxymethylene)-4-methylbenzylacetaldehyde, 4-chloro-alpha-(hydroxymethylene) benzeneacetaldehyde, alpha-nonylidenebenzeneacetaldehyde, and the like, typically in a trans form but also useable in a cis form. In one embodiment, the alpha-beta unsaturated aldehyde is cinnamaldehyde. In another embodiment, the alpha-beta unsaturated aldehyde is a derivative of cinnamaldehyde. The derivative of cinnamaldehyde is not particularlyited and may be any known in the art.

The alpha-beta unsaturated aldehyde may be utilized in any amount as chosen by one of skill in the art. For example, the alpha-beta unsaturated aldehyde may be present in the inhibitor solution itself in an amount of from about 2 to about 50, about 5 to about 45, about 10 to about 40, about 15 to about 35, about 20 to about 30, or about 25 to about 30, about 5, about 10, or about 15, weight percent based on a total weight of the inhibitor solution. After combination with the acid solution, the alpha-beta unsaturated aldehyde may be present in different weight amounts. For example, after combination, the alpha-beta unsaturated aldehyde may be present in an amount of from about 50 to about 4000 parts by weight per one million parts of the combination. In other embodiments, the alpha-beta unsaturated aldehyde is present in an amount of from about 100 to about 3500, about 100 to about 3000, about 100 to about 2500, about 100 to about 2000, about 100 to about 1500, about 100 to about 1000, about 100 to about 500, about 300 to about 1000, about 500 to about 1000, about 500 to about 1500, about 1000 to about 2000, about 1000 to about 3000, about 1000 to about 4000, etc., parts by weight per one million parts of the combination. In various non-limiting embodiments, all values and ranges of values including and between those set forth above are hereby expressly contemplated for use herein.

Referring now to the hydrophobic amine, this amine may be any known in the art. The hydrophobic amine may also be described as a film-forming amine, as is appreciated by those of skill in the art. In various embodiments, the hydrophobic amine is an aliphatic amine, e.g. having from 6 to 20, 7 to 19, 8 to 18, 9 to 17, 10 to 16, 11 to 15, 12 to 14, or 13 to H, carbon atoms. In other embodiments, the hydrophobic amine can be any amine with an attached hydrocarbon chain with 8 or more carbons. These compounds can have multiple amine groups as well as other functional groups such as alcohols and thiols. In various non-limiting embodiments, all values and ranges of values including and between those set forth above are hereby expressly contemplated for use herein.

Alternatively, the hydrophobic amine may be described as an oligo-alkyl-amino amine that may have the formula R¹-[NH—R²-]ₙ-NH₂, wherein R¹ is an unbranched alkyl group having 12 to 18 carbon atoms, R² is an alkyl group having 1 to 4 carbon atoms, and n is a number from 0 to 8. In other embodiments, the hydrophobic acid has mono- or polyamine groups. In one embodiment, the hydrophobic amine is oleyl-propanediamine. In another embodiment, the hydrophobic amine is chosen from N-Oleyl-1,3-propanediamine (Duomeen OL); N-Coco-1,3-propanediamine (Duomeen C); N-Soya-1,3-propanediamine (Duomeen SV); N-tallow-1,3-propanediamine (Duomeen T); Oleylamine, cocoamine, laurylamine, stearylamine, soyaamine, tallowamine, hexadecylamine, octadecylamine, dodecylamine, ethoxylated oleylamine, ethoxylated cocoamine, ethoxylated tallowamine, ethoxylated soyaamine, ethoxylated octadecylamine, ethoxylated hexadecylamine, ethoxylated laurylamine, ethoxylated N-Oleyl-1,3-propanediamine, ethoxylated N-tallow-1,3 -propanediamine, ethoxylated N-soya-1,3 -propanediamine, ethoxylated N-coco-1,3 -propanediamine, tall oil fatty acid imidazoline, cocoimidazoline, oleylimidazoline, stearylimidazoline, propoxylated fatty amines, and combinations thereof In one embodiment, the hydrophobic amine is N-Oleyl-1,3-propanediamine. In various embodimetns, the hydrophobic amine is chosen from oleylpropanediamine, cocopropanediamine, soyapropanediamine, tallowpropanediamine, and combinations thereof.

The hydrophobic amine may be utilized in any amount as chosen by one of skill in the art. For example, the hydrophobic amine may be present in the inhibitor solution itself in an amount of from about 0.1 to about 20, about 0.5 to about 20, about 1 to about 20, about 1 to about 5, about 5 to about 10, about 10 to about 15, about 15 to about 20, about 1, 2, 3, 4, or 5, weight percent based on a total weight of the inhibitor solution. After combination with the acid solution, the hydrophobic amine may be present in different weight amounts. For example, after combination, the hydrophobic amine may be present in an amount of from about 20 to about 2000 parts by weight per one million parts of the combination. In other embodiments, the hydrophobic amine is present in an amount of from about 25 to about 400, about 100 to about 2000, about 100 to about 1500, about 100 to about 1000, about 100 to about 500, about 50 to about 375, about 75 to about 350, about 100 to about 325, about 125 to about 300, about 150 to about 275, about 175 to about 250, about 200 to about 225, etc. parts by weight per one million parts of the combination. In various non-limiting embodiments, all values and ranges of values including and between those set forth above are hereby expressly contemplated for use herein.

Referring now to the oxime, the oxime may also be any known in the art. In various embodiments, the oxime has a general formula R¹R²C═NOH, where R¹ is an organic group and R² may be hydrogen (to be an aldoxime) or an organic group (to be a ketoxime). The oxime may alternatively be any that is generated by the reaction of hydroxylamine with an aldehyde or ketone. In one embodiment, the oxime is a ketoxime. In another embodiment, the oxime is methyl ethyl ketoxime. In still another embodiment, the oxime is cyclohexanone oxime. In further embodiments, the oxime is chosen from methyl ethyl ketoxime, cyclohexanone oxime, and combinations thereof. In other embodiments, the oxime is chosen from methyl methyl ketoxime, methyl ethyl ketoxime, 4-methyl-2-pentanone oxime, ethyl ethyl ketoxime, cyclohexanone oxime, cyclopentanone oxime, acetaldehyde oxime, propionaldehyde oxime, benzaldehyde oxime, acetophenone oxime, and combinations thereof.

The oxime may be utilized in any amount as chosen by one of skill in the art. For example, the oxime may be present in the inhibitor solution itself in an amount of from about 0.1 to about 20, about 0.5 to about 20, about 1 to about 20, about 1 to about 5, about 5 to about 10, about 10 to about 15, about 15 to about 20, about 1, 2, 3, 4, or 5, weight percent based on a total weight of the inhibitor solution. After combination with the acid solution, the oxime may be present in different weight amounts. For example, after combination, the oxime may be present in an amount of from about 20 to about 2000 parts by weight per one million parts of the combination. In other embodiments, the oxime is present in an amount of from about 25 to about 400, about 100 to about 2000, about 100 to about 1500, about 100 to about 1000, about 100 to about 500, about 50 to about 375, about 75 to about 350, about 100 to about 325, about 125 to about 300, about 150 to about 275, about 175 to about 250, about 200 to about 225, etc. parts by weight per one million parts of the combination. In various non-limiting embodiments, all values and ranges of values including and between those set forth above are hereby expressly contemplated for use herein.

Referring back, the inhibitor solution optionally includes formic acid, the surfactant, and the solvent. To be clear, the inhibitor solution may include one, two, or all three of the formic acid, the surfactant, and the solvent, or may be free of one, two, or all three of the formic acid, the surfactant, and the solvent.

In varying embodiments, the hydrophobic amine, oxime, and alpha-beta unsaturated aldehyde may be present in a weight ratio of from about 1:1:5 to about 1:4:20, respectively. In varying embodiments, this weight ratio is about 1:1:5; 1:1:10; 1:1:15; 1:1:20; 1:4:5; 1:4:10; 1:4:15; or 1:4;20, respectively. In various non-limiting embodiments, all values and ranges of values including and between those set forth above are hereby expressly contemplated for use herein.

The formic acid may be of any concentration known in the art. For example, the formic acid is typically utilized as an 85 or 95 wt percent inhibitor solution in water. Similarly, the amount of formic acid included in the composition is not particularly limited and may chosen by one of skill in the art.

The formic acid may be utilized in any amount as chosen by one of skill in the art. For example, the formic acid may be present in the inhibitor solution itself in an amount of from greater than zero to an amount of up to about 50, of from about 1 to about 50, about 5 to about 45, about 10 to about 40, about 15 to about 35, about 20 to about 30, about 25 to about 30, or about 25, 26, 27, 28, 29, or 30, weight percent based on a total weight of the inhibitor solution. After combination with the acid solution, the formic acid may be present in different weight amounts. For example, after combination, the formic acid may be present in an amount of from about 50 to about 5000, about 1000 to about 5000, about 2000 to about 4000, about 3000 to about 5000, about 100 to about 1000, about 500 to about 1000, about 500 to about 1500, about 1500 to about 2500, about 3500 to about 5000, etc., parts by weight per one million parts of the combination. All of the aforementioned amounts typically describe the weight of the formic acid itself and not of the total solution of, e.g., formic acid (85 or 95%) in water. In various non-limiting embodiments, all values and ranges of values including and between those set forth above are hereby expressly contemplated for use herein.

Referring now to the surfactant, the surfactant may also be any known in the art. The surfactant may be anionic, cationic, non-ionic, or zwitterionic, or may include one or more combinations thereof. Any one or more anionic, cationic, non-ionic, or zwitterionic surfactants known in the art may be utilized herein. In one embodiment, the surfactant is ethoxylated tridecyl alcohol.

In one embodiment, the surfactant is or includes an anionic surfactant such as a sulfate, sulfonate, phosphate esters, carboxylate, ammonium lauryl sulfate, sodium lauryl sulfate, sodium laureth sulfate, sodium myreth sulfate, and the like, and combinations thereof. In another embodiment, the surfactant is or includes an anionic surfactant such as dioctyl sodium sulfosuccinate, perfluorooctanesulfonate, perfluorobutanesulfonate, an alkyl-aryl ether phosphate, an alkyl ether phosphate, a carboxylate such as sodium lauroyl sarcosinate and carboxylate-based fluorosurfactants such as perfluorononanoate, perfluorooctanoate, and the like, and combinations thereof. In various embodiments, the anionic surfactant is chosen from alkyl sulfates, such as the sodium alkyl sulfates prepared by the sulfation of higher alcohols derived from coconut oil or tallow fatty alcohols, alkyl aryl sulfonates, such as polypropylene benzene sulfonates, dialkyl sodium sulfosuccinates such as dioctyl sodium sulfosuccinate, and the like, and combinations thereof.

In one embodiment, the surfactant is or includes a cationic surfactant such as octenidine dihydrochloride, cetrimonium bromide, cetylpyridinium chloride, benzalkonium chloride, benzethonium chloride, dimethyldioctadecylammonium chloride, dioctadecyldimethylammonium bromide, and the like, and combinations thereof. In other embodiments, the cationic surfactant includes nitrogen atom-containing quaternary compounds of the general formula R₄N⁺X⁻ wherein the Rs represent the same or different longchain alkyl, cycloalkyl, aryl or heterocyclic groups, and X represents an anion, usually a halide or methosulfate. Among such quaternary compounds are N-alkyl, N-cycloalkyl and N-alkylaryl pyridinium halides such as N-cyclohexylpyridinium bromide, N-octylpyridinium bromide, N-nonylpyridinium bromide, N-decylpyridinium bromide, N-dodecylpyridinium bromide, N,N-dodecyldipyridinium dibromide, N-tetradecylpyridinium bromide, N-laurylpyridinium chloride, N-dodecylbenzylpyridinium chloride, N-dodecylquinolinium bromide quinolinium-(1-naphylenemethyl)chloride and the like. Other quaternary ammonium compounds include monochloromethylated and bischloromethylated pyridinium halides, ethoxylated and propoxylated quaternary ammonium compounds, sulfated etoxylates of alkyl phenols and primary and secondary fatty alcohols, didodecyl dimethylammonium chloride, hexadecyl ethyl dimethylammonium chloride, 2-hydroxy-3 -(2-undecylamidoethylamino)-propane-1-triethylammonium hydroxide, 2-hydroxy-3 -(2-heptadecylamidoethylamino)-propane-1-triethylammonium hydroxide, 2-hydroxy-3 -(2-heptadecylamidoethylamino)-propane-1-triethylammonium hydroxide, and the like, and combinations thereof. The cationic surfactant can also include covalently-bonded nitrogen compounds such as primary amines, secondary amines, or tertiary amines, e.g. dodecyl dimethyl amine.

In one embodiment, the surfactant is or includes a zwitterionic (or amphoteric) surfactant such as sultaines such as (3-[(3 -Cholamidopropyl)dimethylammonio]-1-propanesulfonate), cocamidopropyl hydroxysultaine, betaines such as cocamidopropyl betaine, and the like, and combinations thereof. In one embodiment, the zwitterionic surfactant is coco-beta-aminopropionate or the like.

Relative to the ionic surfactants, the counter ions may be any known in the art. For example, the counterions may be metals such as alkali metals, alkaline earth metals, and transition metals. The counterions may be halides. Alternatively the cations or anions may be ammonium, pyridinium, triethanolamine, tosyls, trifluoromethanesulfonates, methyl sulfate, and the like.

In one embodiment, the surfactant is or includes a non-ionic surfactant such as ethoxylates, fatty alcohol ethoxylates, octaethylene glycol monododecyl ether, pentaethylene glycol monododecyl ether, alkylphenol ethoxylates, nonoxynols, fatty acid ethoxylates, ethoxylated amines and/or fatty acid amides, polyethoxylated tallow amines, cocamide monoethanolamine, cocamide diethanolamine, terminally blocked ethoxylates, poloxamers, fatty acid esters of polyhydroxy compounds, fatty acid esters of glycerol, glycerol monostearate, glycerol monolaurate, fatty acid esters of sorbitol, sorbitan monolaurate, sorbitan monostearate, sorbitan tristearate, fatty acid esters of sucrose, alkyl polyglucosides, alkyl polyglycosides, decyl glucoside, lauryl glucoside, octyl glucoside, amine oxides, lauryldimethylamine oxide, sulfoxides, dimethyl sulfoxide, phosphine oxides, and the like, and combinations thereof. In further embodiments, the non-ionic surfactant is an ethoxylate of an alkyl phenol, a primary fatty alcohol, a secondary fatty alcohol, and the like, including alkyl and alkylaryl polyether alcohols such as the reaction product of trimethyl- 1 -heptanol with seven mols of ethylene oxide, the reaction products of octyl or nonyl phenol with, e.g. from about 8 to 30 mols or more of ethylene oxide, polyoxyethylenepolyoxypropylene block copolymers, and the like, and combinations thereof.

The surfactant may be utilized in any amount as chosen by one of skill in the art. For example, the surfactant may be present in the inhibitor solution itself in an amount of from greater than zero to an amount of about 20, about 1 to about 20, about 5 to about 15, about 10 to about 15, or about 5, 6, 7, 8, 9, or 10, weight percent based on a total weight of the inhibitor solution. After combination with the acid solution, the surfactant may be present in different weight amounts. For example, after combination, the surfactant may be present in an amount of from about 10 to about 3000, about 100 to about 3000, about 500 to about 3000, about 1000 to about 3000, about 1500 to about 3000, about 2000 to about 3000, about 2500 to about 3000, about 500 to about 1000, about 500 to about 1500, about 1500 to about 2500, about 1000 to about 3000, etc. In various non-limiting embodiments, all values and ranges of values including and between those set forth above are hereby expressly contemplated for use herein.

Referring now to the solvent, the solvent may be any known in the art. The solvent may be water and/or an organic solvent. In varying embodiments, the solvent is an alcohol. In other embodiments, the solvent is chosen from methanol, ethanol, isopropanol, propylene glycol, butanol, ethylene glycol, ethylene glycol butyl ether, and combinations thereof. In other embodiments, the solvent is non-toxic, has a high flash point as would be understood by one of skill in the art, is miscible with water, and can dissolve the aforementioned components for use in the inhibitor solution. The solvent is not limited to use in any particular weight amount and is typically utilized in an amount to “balance” the aforementioned components to bring a total up to a scaled 100 parts by total weight of the inhibitor solution. After combination of the inhibitor solution and the acid solution, the solvent may be present in a different weight amount. For example, after combination, the solvent may be present in any amount as calculated for example if about 0.1 to about 5 weight percent of the inhibitor solution is present in the acid solution.

Referring back, the method also includes applying the acid solution to the substrate to remove mineral scales therefrom and the step of applying the corrosion inhibitor solution to the substrate to minimize corrosion thereof. The step of applying the acid solution may occur before, simultaneously with, or after, the step of applying the corrosion inhibitor solution. Moreover, the acid solution may be combined with the corrosion inhibitor solution and the two may be applied at the same time, e.g. as described above. In various embodiments, the inhibitor solution and the acid solution are combined such that, after combination, the combination includes about 0.1 to about 5, about 0.5 to about 1, about 0.5 to about 4.5, about 1 to about 4, about 1.5 to about 3.5, about 2 to about 3, or about 2.5 to about 3, weight percent of the inhibitor solution based on a total weight of the combination. In various embodiments, the method includes the step of combining the corrosion inhibitor solution and the acid solution and applying the combination to the steel substrate at a temperature of from about 80° C. to about 300° C. to remove the calcite scales therefrom while minimizing corrosion thereof. In various non-limiting embodiments, all values and ranges of values including and between those set forth above are hereby expressly contemplated for use herein.

The steps of applying the acid solution and the inhibitor solution may each be repeated one or more times. For example, these steps may be alternated and repeated multiple times. In various embodiments, the method may also include the step of neutralizing the acid. The step of neutralizing may be any known in the art and may include water and/or any basic compound. Moreover, the method may include the step of rinsing the substrate using water or any other suitable rinse, as is selected by one of skill in the art.

These steps are not particularly limited in terms of time of application, temperature of application, or pressure of application. The acid solution and/or the inhibitor solution and/or the combination may be applied for any amount of time, as is chosen by one of skill in the art. This time may be seconds, minutes, or hours. Moreover, the acid solution and/or the inhibitor solution and/or the combination may be applied at atmospheric pressure or at an increased pressure. For example, the acid solution and/or the inhibitor solution and/or the combination may be sprayed onto the substrate using a high pressure nozzle. The acid solution and/or the inhibitor solution and/or the combination may be applied using any mechanism in the art including, but not limited to, dipping, spraying, coating, brushing, misting, etc. In various embodiments, the acid solution and/or the inhibitor solution and/or the combination are applied at a temperature of from about 60 to about 300, about 75 to about 275, about 100 to about 250, about 125 to about 225, about 150 to about 200, or about 175 to about 200, ° C. In various non-limiting embodiments, all values and ranges of values including and between those set forth above are hereby expressly contemplated for use herein.

The method of this disclosure reduces or minimizes corrosion of the substrate. This corrosion can be measured as follows. For example, two C1010 steel coupons can be weighed to determine an initial weight. These coupons can then be attached to an alumina screw and separated with alumina nuts and washers. The coupons can then be submerged in a 200 mL solution of 15 wt % hydrochloric acid and 0.5 wt % of the inhibitor solution. This 200 mL solution can then be heated in an oil bath to about 95° C. After 3 hours, the coupons can be removed and rinsed with deionized water and dried. The coupons can then be cleaned to remove rust and any other deposits. The coupons can then be weighed to determine the final weight. Weight loss can then be calculated as the difference between the initial weight and the final weight. The corrosion rate in mm per year is then calculated using the aforementioned weight loss using the following equation:

Corrosion rate=[(weight loss)(8750)]/[(alloy density)(Surface Area)(Exposure time)]

wherein weight loss is in grams, alloy density is in g/cm³, surface area is in cm², and exposure time is in hours. The corrosion rate in mm per year is then converted to mm by multiplying by the time in years. This resulting value represents the thickness of the coupons lost in mm over a 3 hour test.

In various embodiments, the corrosion is evaluated using C1010 steel and the aforementioned test method and the corrosion is less than 0.010, 0.009, 0.008, 0.007, 0.006; 0.005, 0.004, 0.003, 0.002, or 0.001, mm. In various non-limiting embodiments, all values and ranges of values including and between those set forth above are hereby expressly contemplated for use herein.

This disclosure also provides an additional embodiment of the method. In this embodiment, the acid solution includes about 5 to about 25 wt % of hydrochloric acid. Also in this embodiment, the corrosion inhibitor solution, prior to any combination with the acid solution, includes cinnamaldehyde present in an amount of from 5 to about 10, e.g. about 10, weight percent based on a total weight of the corrosion inhibitor solution, oleyl-propanediamine present in an amount of from 1 to about 3, e.g. about 2, weight percent based on a total weight of the corrosion inhibitor solution, methyl ethyl ketoxime present in an amount of from 1 to about 3, e.g. about 2, weight percent based on a total weight of the corrosion inhibitor solution, formic acid present in an amount of about 25 to about 30, e.g. about 27, weight percent based on total weight of the corrosion inhibitor solution, a surfactant present in an amount of from about 5 to about 10, e.g. about 8, weight percent based on total weight of the corrosion inhibitor solution, and an alcohol solvent comprising a balance of the corrosion inhibitor solution. Moreover, this embodiment includes the step of applying the acid solution to the steel substrate to remove the calcite scales therefrom and the step of applying the corrosion inhibitor solution to the steel substrate at a temperature of from about 80° C. to about 300° C. to minimize corrosion thereof. This disclosure also contemplates the aforementioned corrosion inhibitor solution itself, independent of any acid solution.

This disclosure also provides yet another additional embodiment of the method. In this embodiment, the acid solution includes about 5 to about 25 wt % of hydrochloric acid. Also in this embodiment, the corrosion inhibitor solution includes cinnamaldehyde present in an amount of from about 400 to about 1000 parts per one million parts of a combination with the acid solution, oleyl-propanediamine present in an amount of from about 25 to about 150 parts per one million parts of a combination with the acid solution, methyl ethyl ketoxime present in an amount of from about 25 to about 150 parts per one million parts of a combination with the acid solution, formic acid present in an amount of about 50 to about 5000 parts by weight per one million parts of a combination with the acid solution, a surfactant present in an amount of from about 10 to about 3000 parts by weight per one million parts by weight of a combination with the acid solution, and an alcohol solvent comprising a balance of a combination with the acid solution. Moreover, this embodiment includes the step of applying the acid solution to the steel substrate to remove the calcite scales therefrom and the step of applying the corrosion inhibitor solution to the steel substrate at a temperature of from about 80° C. to about 300° C. to minimize corrosion thereof. This disclosure also contemplates the aforementioned combination itself, and any combinations described herein, independent of any method described herein.

This disclosure even further provides the corrosion inhibitor solution itself including the alpha-beta unsaturated aldehyde, the hydrophobic amine, and the oxime. The inhibitor solution itself may be any as described above. Moreover, this corrosion inhibitor solution may form any combination if combined with any acid solution described herein.

### EXAMPLES

A series of examples are formed according to this disclosure and comparatively. These examples are then evaluated to determine corrosion when exposed to varying solutions.

In a first example (Example 1), 1.00 grams of an inhibitor solution including 10% cinnamaldehyde, 1% oleyl propane diamine, 1% methylethylketoxime, 30% formic acid (95%), 8% Ethal TDA-9 (surfactant), and 50% propylene glycol (solvent) is added to 200 mL of 15% HCl. Two pre-weighed C1010 coupons are submerged in this 200 mL solution according to the method described above to determine corrosion loss. The corrosion loss is determined to be 0.0062 mm.

In a second example (Example 2), 1.00 grams of a solution including 10% cinnamaldehyde, 2% oleyl propane diamine, 2% 4-methyl-2-pentanone oxime, 30% formic acid (95%), 8% Ethal TDA-9 (surfactant), 48% propylene glycol (solvent) is added to 200 mL of 15% HCl. Two pre-weighed C1010 coupons are submerged in this 200 mL solution according to the method described above to determine corrosion loss. The corrosion loss is determined to be 0.0055 mm.

Additional examples 3-20 (Ex. 3-20) are set forth below in Table 1 wherein 200 mL of 15% HCl is used and varying inhibitors solutions are added thereto, as set forth below. Two pre-weighed C1010 coupons are submerged in this 200 mL solution for each example according to the method described above to determine corrosion loss. The corrosion loss is also set forth in Table 1. Some of the examples are comparative and some are representative of various embodiments of this disclosure. Examples 3-20 also each include 30 wt % formic acid, (95%), 8 wt % Ethal TDA-9 (surfactant), and propylene glycol (solvent). A single asterisk (*) is indicative of a comparative embodiment. A double asterisk (**) is indicative of an embodiment of this disclosure

TABLE 1

| | | | | Concentration in the solution | | |
|---|---|---|---|---|---|---|
| | | | Thickness | after mixing with HCl (ppm) | | |
| | | Oxime and/or | lost | | | Hydrophobic |
| Ex. | Aldehyde | Hydrophobic Amine | (mm) | Aldehyde | Oxime | Amine |
| 3* | None | MEKOR | 0.1985 | 0 | 5000 | 0 |
| 4* | None | 2% Duomeen OL, | 0.1539 | 0 | 100 | 100 |
| | | 2% MEKOR | | | | |
| 5* | None | Cyclohexanone | 0.1029 | 0 | 5000 | 0 |
| | | oxime | | | | |
| 6** | 2% | 2% MEKOR, | 0.0403 | 100 | 100 | 100 |
| | | 2% Duomeen OL | | | | |
| 7* | 10% | 2% MEKOR | 0.0131 | 500 | 100 | 0 |
| 8** | 6% | 2% MEKOR, | 0.0128 | 300 | 100 | 100 |
| | | 2% Duomeen OL | | | | |
| 9* | 10% | 2% 4-Methyl-2- | 0.0118 | 500 | 100 | 0 |
| | | pentanone oxime | | | | |
| 10** | 10% | 2% MEKOR, | 0.0103 | 500 | 100 | 100 |
| | | 2% oleylamine | | | | |
| 11** | 10% | 0.5% MEKOR, | 0.0099 | 500 | 25 | 100 |
| | | 2% Duomeen OL | | | | |
| 12* | 10% | 2% Cyclopentanone | 0.0098 | 500 | 100 | 0 |
| | | oxime | | | | |
| 13* | 10% | 2% Cyclohexanone | 0.0096 | 500 | 100 | 0 |
| | | oxime | | | | |
| 14** | 10% | 2% MEKOR, | 0.0065 | 500 | 100 | 100 |
| | | 2% Duomeen SV | | | | |
| 15** | 10% | 1% MEKOR, | 0.0062 | 500 | 50 | 50 |
| | | 1% Duomeen OL | | | | |
| 16** | 10% | 2% MEKOR, | 0.0061 | 500 | 100 | 100 |
| | | 2% Duomeen C | | | | |
| 17** | 10% | 2% Duomeen OL, | 0.0058 | 500 | 100 | 100 |
| | | 2% MEKOR | | | | |
| 18** | 10% | 2% MEKOR, | 0.0058 | 500 | 100 | 25 |
| | | 0.5% Duomeen OL | | | | |
| 19** | 10% | 2% 4-methyl-2- | 0.0055 | 500 | 100 | 100 |
| | | pentanone oxime, | | | | |
| | | 2% Duomeen OL | | | | |
| 20** | 10% | 2% Cyclohexanone | 0.0047 | 500 | 100 | 100 |
| | | oxime, | | | | |
| | | 2% Duomeen OL | | | | |

In Table 1, the components are as follows:

“Ex.” Represents Example numbers 3-20.

Aldehyde is cinnamaldehyde that is commercially available from Sigma Aldrich.

Duomeen OL is oleylpropanediamine that is commercially available from Akzo Nobel.

Duomeen C is cocopropanediamine that is commercially available from Akzo Nobel.

Duomeen SV is soyapropanediamine that is commercially available from Akzo Nobel.

MEKOR is methyl ethyl ketoxime that is commercially available from Solenis.

The results set forth above both relative to Examples 1 and 2 and Examples 3-20 set forth in Table 1 show that the following observations can be made:

Example 1**—This data shows that excellent results are produced using cinnamaldehyde, oleyl propane diamine, and ketoximes.

Example 2**—This data shows that excellent results are produced using cinnamaldehyde, oleyl propane diamine, and oximes.

Example 3*—This data shows that oximes require cinnamaldehyde and the hydrophobic amine to work well.

Example 4*—This data shows that cinnamaldehyde is needed to minimize corrosion.

Example 5*—This data shows that oximes require cinnamaldehyde and the hydrophobic amine to work well.

Example 6**—This data shows that particular levels of cinnamaldehyde are needed to minimize corrosion.

Example 7*—This data shows that oximes provide protection against corrosion in combination with cinnamaldehyde.

Example 8**—This data shows that particular levels of cinnamaldehyde are needed to minimize corrosion.

Example 9*—This data shows that oximes provide protection against corrosion in combination with cinnamaldehyde.

Example 10**—This data shows that alternative hydrophobic amines can be used.

Example 11**—This data shows that particular levels of MEKOR are needed to minimize corrosion.

Example 12*—This data shows that oximes provide protection against corrosion in combination with cinnamaldehyde.

Example 13**—This data shows that oximes provide protection against corrosion in combination with cinnamaldehyde.

Example 14**—This data shows that alternative hydrophobic amine can be used.

Example 15**—This data shows that varying levels of Duomeen OL and MEKOR can be used to minimize corrosion.

Example 16**—This data shows that alternative hydrophobic amine can be used.

Example 17**—This data shows that excellent results are produced using cinnamaldehyde, Duomeen OL, and several oximes.

Example 18**—This data shows that particular levels of the hydrophobic amine can be used.

Example 19**—This data shows that excellent results are produced using cinnamaldehyde, Duomeen OL, and several oximes.

Example 20**—This data shows that excellent results are produced using cinnamaldehyde, Duomeen OL, and several oximes.

More specifically, this data shows surprisingly shows that use of the cinnamaldehyde, the varying hydrophobic amines, and the varying oximes produce superior and unexpected results as compared to using each alone or using compositions that do not include one or more of the cinnamaldehyde, the varying hydrophobic amines, or the varying oximes. This data also shows that a weight ratios of the hydrophobic amine:oxime:aldehyde from about 1:1:5 to about 1:4:20 produce superior and unexpected results.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A method of removing mineral scales from a substrate with minimized corrosion of the substrate, said method comprising the steps of:
providing an acid solution comprising a mineral acid, an organic acid, or a combination thereof;
providing a corrosion inhibitor solution comprising:
an alpha-beta unsaturated aldehyde;
a hydrophobic amine; and
an oxime; and optionally formic acid;
a surfactant; and
a solvent;
applying the acid solution to the substrate to remove mineral scales therefrom; and
applying the corrosion inhibitor solution to the substrate to minimize corrosion thereof.

2. The method of claim 1 wherein the alpha-beta unsaturated aldehyde is cinnamaldehyde.

3. The method of claim 1 wherein the corrosion inhibitor solution further comprises the formic acid, the surfactant, and the solvent.

4. The method of claim 1 wherein the hydrophobic amine is chosen from oleyl-propanediamine, cocopropanediamine, soyapropanediamine, tallowpropanediamine, and combinations thereof.

5. The method of claim 1 wherein the hydrophobic amine is oleyl-propanediamine.

6. The method of claim 1 wherein the oxime is chosen from methyl ethyl ketoxime, cyclohexanone oxime, and combinations thereof.

7. The method of claim 1 wherein the oxime is methyl ethyl ketoxime.

8. The method of claim 1 further comprising the step of combining the acid solution and the corrosion inhibitor solution such that, after combination, the alpha-beta unsaturated aldehyde is present in an amount of from about 50 to about 4000 parts per one million parts of the combination.

9. The method of claim 1 further comprising the step of combining the acid solution and the corrosion inhibitor solution such that, after combination, the alpha-beta unsaturated aldehyde is present in an amount of from about 300 to about 1000 parts per one million parts of the combination.

10. The method of claim 1 further comprising the step of combining the acid solution and the corrosion inhibitor solution such that, after combination, the hydrophobic amine is present in an amount of from about 20 to about 2000 parts per one million parts of the combination.

11. The method of claim 1 further comprising the step of combining the acid solution and the corrosion inhibitor solution such that, after combination, the hydrophobic amine is present in an amount of from about 25 to about 400 parts per one million parts of the combination.

12. The method of claim 1 further comprising the step of combining the acid solution and the corrosion inhibitor solution such that, after combination, the oxime is present in an amount of from about 20 to about 2000 parts per one million parts of the combination.

13. The method of claim 1 further comprising the step of combining the acid solution and the corrosion inhibitor solution such that, after combination, the oxime is present in an amount of from about 25 to about 400 parts per one million parts of the combination.

14. The method of claim 1 wherein the formic acid is utilized and further comprising the step of combining the acid solution and the corrosion inhibitor solution such that, after combination, the formic acid is present in an amount of from about 50 to about 5000 parts per one million parts of the combination.

15. The method of claim 1 wherein the solvent is utilized and is an alcohol.

16. The method of claim 1 wherein the surfactant is utilized and further comprising the step of combining the acid solution and the corrosion inhibitor solution such that, after combination, the surfactant is present in an amount of from about 10 to about 3000 parts per one million parts of the combination.

17. The method of claim 1 wherein the step of applying the corrosion inhibitor occurs at a temperature of from about 60° C. to about 300° C.

18. The method of claim 1 wherein corrosion is evaluated using C1010 steel and the corrosion is less than 0.006 mm after a three hour evaluation.

19. A method of removing calcite scales from a steel substrate with minimized corrosion of the steel substrate, said method comprising the steps of:
providing an acid solution comprising about 5 to about 25 wt % of hydrochloric acid;
providing a corrosion inhibitor solution comprising cinnamaldehyde, oleyl-propanediamine, methyl ethyl ketoxime, formic acid, a surfactant, and an alcohol solvent;
combining the corrosion inhibitor solution and the acid solution; and
applying the combination to the steel substrate at a temperature of from about 80° C. to about 300° C. to remove the calcite scales therefrom while minimizing corrosion thereof,
wherein corrosion is evaluated using C1010 steel and the corrosion is less than 0.006 mm after a three hour evaluation; and
wherein the cinnamaldehyde is present in an amount of from about 400 to about 1000 parts per one million parts of the combination;
the oleyl-propanediamine is present in an amount of from about 25 to about 150 parts per one million parts of the combination;
the methyl ethyl ketoxime is present in an amount of from about 25 to about 150 parts per one million parts of the combination;
the formic acid is present in an amount of about 50 to about 5000 parts per one million parts of the combination;
the surfactant is present in an amount of from about 10 to about 3000 parts per one million parts of the combination.

20. A corrosion inhibitor solution comprising:
an alpha-beta unsaturated aldehyde;
a hydrophobic amine; and
an oxime; and optionally formic acid;
a surfactant; and
a solvent.
